(19) United States
(12) Patent Application Publication
(10) Pub. No.: US 2021/0345638 A1
(43) Pub. Date: Nov. 11, 2021

(54) SUGAR REDUCTION IN FOOD PRODUCTS

(71) Applicant: DOUXMATOK LTD, Tel Aviv (IL)

(72) Inventors: David Tsivion, Kfar Shhmaryahu (IL); Alejandro Marabi, Tel Aviv (IL); Gal Shimoni, Tel Aviv (IL); Tamar Dolev, Zichron Yaakov (IL)

(21) Appl. No.: 16/870,272

(22) Filed: May 8, 2020

(51) Int. Cl. A23G 3/42; A23G 3/36; A23L 29/30; A23L 29/294; A23L 33/24; A23L 33/125

(52) U.S. Cl. CPC A23G 3/42; A23G 3/362; A23L 33/125; A23L 29/294; A23L 33/24; A23L 29/35

(57) ABSTRACT

The present disclosure provides compositions including food products having reduced sugar content and methods of making the same. The compositions provided herein may be amorphous and may include one or more components that provide a dietary or nutritional benefit.

### BACKGROUND

Sugar candies can be broadly divided into two groups: crystalline candies and amorphous candies. Crystalline candies derive their name from the crystalline microscopic arrangement of the sucrose molecules, forming crystals. These crystals can be formed in different sizes and numbers, but they are all made of sugar (e.g., sucrose) molecules that are arranged in an exact periodic manner. The crystalline structure has an influence on the texture and as a result they are easy to bite or cut into.

In contrast, in amorphous candies, the sucrose molecules are not organized in crystals with long-range periodic order, and therefore it is present in a rubbery or glassy state. Such food products often have higher sugar concentrations, and the texture may be chewy, hard, or brittle.

Today, and due to high obesity rates globally, and mainly among children, there is a clear need to reduce the amount of sugar ingested by the population. However, due to the natural preference of sweet foods, it is imperative to manage this property in foods targeted to children. Typically, when manufacturing sugar-reduced candies, the sugars content of the original product is reduced, and the lost bulk is compensated by “fillers” (e.g., bulking agents) which may have lower caloric value.

The present disclosure provides compositions having reduced sugar content compared to other amorphous food products often without suffering a reduction in sweetness and methods of preparing the same.

### SUMMARY

The present disclosure recognizes the need to provide amorphous food products having reduced sugar content and methods of making the same. The amorphous food products provided herein may include one or more components that provide a dietary or nutritional benefit. Such components may replace other components used in other food products that do not provide such a dietary or nutritional benefit, or may otherwise detract from the quality of the food product. For example, such other components may reduce the sweetness of the food product or require addition of a sweetener material to compensate for their inclusion in the food product. In some cases, a component may be an interfering agent used to prevent crystallization during the production of the food product. For example, an interfering agent may be a caloric, crystallization-interfering agent such as glucose syrup or corn syrup or a calorie-reduced, crystallization-interfering agent such as a dietary fiber.

In an aspect, the present disclosure provides a candy product comprising a dietary fiber and a sweetener material that comprises sucrose, wherein the candy product (i) comprises less than 60% weight/weight (w/w) of a caloric, crystallization-interfering agent, (ii) is amorphous at room temperature, and (iii) has a soft or chewy texture.

In some embodiments, the dietary fiber comprises soluble fiber, non-digestible fiber, or insoluble fiber. In some embodiments, the dietary fiber comprises an oligosaccharide or a polysaccharide. In some embodiments, the dietary fiber is selected from the group consisting of dextrin, maltodextrin, inulin, psyllium, beta-glucan, lignin, chitin, galactomannan, resistant starch, arabinoxylan, glucomannan, pectin, cellulose, methylcellulose, hemicellulose, and combinations thereof.

In some embodiments, the sweetener material consists essentially of sucrose.

In some embodiments, the sweetener material comprises a carrier material associated with sucrose. In some embodiments, the carrier material is silica. In some embodiments, the sweetener material comprises sucrose that has been homogenized with the carrier material.

In some embodiments, the caloric, crystallization-interfering agent is selected from the group consisting of glucose syrup, corn syrup, honey, hydrogenated starch hydrolysate, and a combination thereof. In some embodiments, the caloric, crystallization-interfering agent is glucose syrup or corn syrup. In some embodiments, the candy product has a higher relative sweetness (RS) than a control candy product without the caloric, crystallization-interfering agent. In some embodiments, the candy product is essentially free of the caloric, crystallization-interfering agent.

In some embodiments, the candy product further comprises one or more flavors, dyes, or acids.

In some embodiments, the dietary fiber is present at a concentration of at least 10% (w/w). In some embodiments, the candy product comprises from 10% to 60% of the sweetener material (w/w) relative to the candy product, exclusive of any incorporated elements. In some embodiments, the ratio of sweetener material to the calorie-reduced, crystallization-interfering agent in the candy product is from 1:10 to 10:1, from 1:5 to 5:1, from 1:2 to 2:1, or from 1:1.5 to 1.5:1. In some embodiments, the candy product comprises at least about 10% water (w/w) relative to the composition, exclusive of any incorporated elements.

In some embodiments, the candy product comprises a gelling agent. In some embodiments, the candy product is a gummy candy, jelly candy, cotton candy, or marshmallow candy. In some embodiments, the candy product further comprises protein, fat, or a combination thereof, exclusive of any incorporated elements. In some embodiments, the candy product is a nougat, taffy, or caramel.

In some embodiments, the candy product comprises one or more incorporated elements, which incorporated elements are separate from the sweetener material. In some embodiments, the one or more incorporated elements comprise or are derived from nuts, seeds, cereals, confectionaries, chocolates, or fruits.

In another aspect, the present disclosure provides a composition comprising a (i) a sweetener material comprising sucrose associated with a carrier material and (ii) a dietary fiber, wherein the dietary fiber is present in an amount sufficient to at least partially prevent crystallization of the sweetener material in the composition under crystallizing conditions.

In some embodiments, the crystallizing conditions comprise elevated temperature and/or the sweetener material and the dietary fiber being present in a saturated or supersaturated aqueous solution.

In some embodiments, the composition comprises less than about 60% of a caloric, crystallization-interfering agent weight/weight (w/w) relative to the composition. In some embodiments, the caloric, crystallization-interfering agent is selected from the group consisting of glucose syrup, corn syrup, honey, hydrogenated starch hydrolysate, and a combination thereof. In some embodiments, the caloric, crystallization-interfering agent is glucose syrup or corn syrup. In some embodiments, the composition is essentially free of a caloric, crystallization-interfering agent.

In some embodiments, the sweetener material consists essentially of sucrose.

In some embodiments, the carrier material is silica. In some embodiments, the sweetener material comprises about 0.001-4% carrier material weight/weight relative to sucrose. In some embodiments, the sweetener material comprises sucrose that has been homogenized with the carrier material. In some embodiments, the composition further comprises one or more flavors, dyes, or acids. In some embodiments, the composition comprises at least 10% of the at least one calorie-reduced, crystallization-interfering agent (w/w) relative to the composition. In some embodiments, the dietary fiber comprises soluble fiber, non-digestible fiber, or insoluble fiber. In some embodiments, the dietary fiber comprises an oligosaccharide or a polysaccharide. In some embodiments, the dietary fiber is selected from the group consisting of dextrin, maltodextrin, inulin, psyllium, beta-glucan, lignin, chitin, pectin, galactomannan, resistant starch, arabinoxylan, glucomannan, cellulose, methylcellulose, hemicellulose, and combinations thereof. In some embodiments, the dietary fiber is maltodextrin, inulin, or a combination thereof.

In some embodiments, the composition is a solid or semi-solid composition. In some embodiments, the composition is amorphous at room temperature. In some embodiments, the composition has a soft or chewy texture. In some embodiments, the composition comprises from 10% to 60% of the sweetener material (w/w) relative to the composition, exclusive of any incorporated elements. In some embodiments, the ratio of sweetener material to the dietary fiber in the composition is from 1:10 to 10:1, from 1:5 to 5:1, from 1:2 to 2:1, or from 1:1.5 to 1.5:1. In some embodiments, the composition comprises at least about 10% water (w/w) relative to the composition, exclusive of any incorporated elements. In some embodiments, the composition comprises a gelling agent. In some embodiments, the composition is a gummy candy, jelly candy, cotton candy, or marshmallow candy. In some embodiments, the composition further comprises protein, fat, or combination thereof, exclusive of any incorporated elements. In some embodiments, the composition is a nougat, taffy, or caramel.

In some embodiments, the composition has a hard or brittle texture.

In some embodiments, the composition comprises one or more incorporated elements, which incorporated elements are separate from the sweetener material. In some embodiments, the one or more incorporated elements comprise or are derived from nuts, seeds, cereals, confectionaries, chocolates, or fruits.

In a further aspect, the present disclosure provides a method of preparing a consumable product, the method comprising: combining a dietary fiber and a sweetener material that comprises sucrose to provide a sweetener mixture, wherein the dietary fiber is added in an amount sufficient to at least partially prevent crystallization of the sweetener material under crystallizing conditions, and wherein the consumable product has a soft or chewy texture.

In some embodiments, the consumable product comprises less than 60% of a caloric, crystallization-interfering agent weight/weight (w/w) relative to the consumable product. In some embodiments, the consumable product comprises less than 20% of a caloric, crystallization-interfering agent weight/weight (w/w) relative to the consumable product. In some embodiments, the consumable product is essentially free of the caloric, crystallization-interfering agent. In some embodiments, the method does not comprise the use of a caloric, crystallization-interfering agent. In some embodiments, the caloric, crystallization-interfering agent is selected from the group consisting of glucose syrup, corn syrup, honey, hydrogenated starch hydrolysate, and a combination thereof.

In some embodiments, the sweetener mixture is a syrup. In some embodiments, the sweetener mixture is a supersaturated solution.

In some embodiments, the crystallizing conditions comprise elevated temperature and/or the sweetener mixture being included in a saturated or supersaturated solution.

In some embodiments, the sweetener material consists essentially of sucrose.

In some embodiments, the sweetener material comprises a carrier material associated with sucrose. In some embodiments, the carrier material is silica. In some embodiments, the sweetener material comprises sucrose that has been homogenized with the carrier material. In some embodiments, the sweetener material comprises about 0.001-4% carrier material weight/weight relative to sucrose.

In some embodiments, one or more flavors, dyes, or acids are added to the sweetener mixture.

In some embodiments, the dietary fiber comprises soluble fiber, non-digestible fiber, or insoluble fiber. In some embodiments, the dietary fiber comprises an oligosaccharide or a polysaccharide. In some embodiments, the dietary fiber is selected from the group consisting of dextrin, maltodextrin, inulin, psyllium, beta-glucan, lignin, chitin, galactomannan, resistant starch, arabinoxylan, glucomannan, pectin, cellulose, methylcellulose, hemicellulose, and combinations thereof. In some embodiments, the sweetener mixture comprises at least 10% of the dietary fiber (w/w) relative to the sweetener mixture.

In some embodiments, the consumable product is a solid or semi-solid composition. In some embodiments, the consumable product is amorphous. In some embodiments, the consumable product has a soft or chewy texture. In some embodiments, the sweetener mixture comprises between about 10-60% of the dietary fiber (w/w) relative to the sweetener mixture, exclusive of any incorporated elements. In some embodiments, the consumable product comprises between about 20-50% of the dietary fiber weight/weight relative to the consumable product, exclusive of any incorporated elements. In some embodiments, the sweetener mixture comprises between about 10-60% sweetener material (w/w) relative to the sweetener mixture, exclusive of any incorporated elements. In some embodiments, the consumable product comprises between about 20-50% sweetener material (w/w) relative to the consumable product, exclusive of any incorporated elements. In some embodiments, the consumable product comprises a higher percentage by weight of the dietary fiber than of the sweetener material. In some embodiments, the consumable product comprises about the same percentage by weight of the dietary fiber and of the sweetener material. In some embodiments, the method further comprises heating the sweetener mixture to provide a heated sweetener mixture. In some embodiments, the sweetener mixture is heated to between about 118-155° C. In some embodiments, the method further comprises cooling the heated sweetener mixture. In some embodiments, cooling the heated sweetener mixture comprises subjecting the heated sweetener mixture to a controlled cooling process. In some embodiments, cooling the heated sweetener mixture comprises depositing the heated sweetener mixture onto a cooling table or into molds.

In some embodiments, the consumable product comprises at least 10% of the water (w/w) relative to the consumable product, exclusive of any incorporated elements.

In some embodiments, the method further comprises adding a gelling agent to the sweetener mixture. In some embodiments, the consumable product is a gummy candy, jelly candy, cotton candy, or marshmallow candy. In some embodiments, the consumable product further comprises protein, fat, or combination thereof, exclusive of any incorporated elements. In some embodiments, the consumable product is a nougat, taffy, or caramel.

In some embodiments, the consumable product comprises one or more incorporated elements, which incorporated elements are separate from the sweetener material. In some embodiments, the one or more incorporated elements comprise or are derived from nuts, seeds, cereals, confectionaries, chocolates, or fruits.

In another aspect, the present disclosure provides a method of preparing a consumable product, the method comprising combining an interfering agent and a sweetener material that comprises sucrose to provide a sweetener mixture, wherein the interfering agent is (i) a dietary fiber or (ii) a combination of a dietary fiber and a caloric, crystallization-interfering agent, wherein the sweetener mixture comprises less than 50% of the caloric, crystallization-interfering agent, wherein the consumable product is amorphous at room temperature, and wherein the consumable product has a soft or chewy texture.

In some embodiments, the sweetener mixture comprises less than 20% of the caloric, crystallization-interfering agent. In some embodiments, the consumable product is essentially free of the caloric, crystallization-interfering agent. In some embodiments, the method does not comprise the use of a caloric, crystallization-interfering agent. In some embodiments, the caloric, crystallization-interfering agent is selected from the group consisting of glucose syrup, corn syrup, honey, hydrogenated starch hydrolysate, and a combination thereof.

In some embodiments, the sweetener mixture is a syrup. In some embodiments, the sweetener mixture is a supersaturated solution.

In some embodiments, the sweetener material consists essentially of sucrose.

In some embodiments, the sweetener material comprises a carrier material associated with sucrose. In some embodiments, the sweetener material comprises about 0.001-4% carrier material weight/weight relative to sucrose. In some embodiments, the sweetener material comprises sucrose that has been homogenized with the carrier material.

In some embodiments, one or more flavors, dyes, or acids are added to the sweetener mixture.

In some embodiments, the dietary fiber comprises soluble fiber, non-digestible fiber, or insoluble fiber. In some embodiments, the dietary fiber comprises an oligosaccharide or a polysaccharide. In some embodiments, the dietary fiber is selected from the group consisting of dextrin, maltodextrin, inulin, psyllium, beta-glucan, lignin, chitin, galactomannan, resistant starch, arabinoxylan, glucomannan pectin, cellulose, methylcellulose, hemicellulose, and a combination thereof. In some embodiments, the sweetener mixture comprises at least 10% of the dietary fiber weight/weight relative to the sweetener mixture. In some embodiments, the consumable product is a solid or semi-solid composition. In some embodiments, the sweetener mixture comprises between about 10-60% of the dietary fiber weight/weight relative to the sweetener mixture, exclusive of any incorporated elements. In some embodiments, the consumable product comprises between about 20-50% of the dietary fiber weight/weight relative to the consumable product, exclusive of any incorporated elements. In some embodiments, the sweetener mixture comprises between about 10-60% sweetener material weight/weight relative to the sweetener mixture, exclusive of any incorporated elements. In some embodiments, the consumable product comprises between about 20-50% sweetener material weight/weight relative to the consumable product, exclusive of any incorporated elements. In some embodiments, the consumable product comprises a higher percentage by weight of the dietary fiber than of the sweetener material. In some embodiments, the consumable product comprises about the same percentage by weight of the dietary fiber and of the sweetener material.

In some embodiments, the method further comprises heating the sweetener mixture to provide a heated sweetener mixture. In some embodiments, the sweetener mixture is heated to between about 118-155° C. In some embodiments, the method further comprises cooling the heated sweetener mixture. In some embodiments, cooling the heated sweetener mixture comprises subjecting the heated sweetener mixture to a controlled cooling process. In some embodiments, cooling the heated sweetener mixture comprises depositing the heated sweetener mixture onto a cooling table or into molds. In some embodiments, the consumable product comprises at least 10% of the water weight/weight relative to the consumable product, exclusive of any incorporated elements.

In some embodiments, the method further comprises adding a gelling agent to the sweetener mixture. In some embodiments, the consumable product is a gummy candy, jelly candy, cotton candy, or marshmallow candy.

In some embodiments, the consumable product further comprises protein, fat, or combination thereof. In some embodiments, the consumable product is a nougat, taffy, or caramel.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

### Amorphous Food Products

In an aspect, the present disclosure provides a food product (e.g., a candy product) comprising a sweetener material and less than 60% weight/weight (w/w) of a caloric, crystallization-interfering agent or a derivative thereof, wherein the food product is amorphous at room temperature. For example, the amorphous food product may comprise less than 60% w/w, less than 55% w/w, less than 50% w/w, less than 45% w/w, less than 40% w/w, less than 35% w/w, less than 30% w/w, less than 25% w/w, less than 20% w/w, less than 15% w/w, less than 10% w/w, less than 5% w/w, less than 4% w/w, less than 3% w/w, less than 2% w/w, less than 1% w/w, less than 0.5% w/w, less than 0.1% w/w, less than 0.01% w/w, or less than 0.001% w/w of a caloric, crystallization-interfering agent or a derivative thereof. The food product may also comprise a calorie-reduced, crystallization interfering agent or derivative thereof. The calorie-reduced, crystallization interfering agent may be a non-caloric, crystallization interfering agent. The calorie-reduced, crystallization interfering agent may comprise a dietary fiber. The sweetener material may comprise sucrose. The sweetener material may comprise a carrier material (e.g., silica) associated with a sweetener carbohydrate and/or polyol (e.g., sucrose). For example, the sweetener material may comprise a sweetener carbohydrate and/or polyol (e.g., sucrose) that has been homogenized with a carrier material (e.g., silica). The food product (e.g., candy product) may have a soft or chewy texture.

The food (e.g., candy) product may comprise a non-caloric, crystallization-interfering agent or derivative thereof. The food (e.g., candy) product may comprise a calorie-reduced, crystallization-interfering agent that may be a dietary fiber. A dietary fiber may comprise soluble fiber, non-digestible fiber, and/or insoluble fiber. A dietary fiber may comprise an oligosaccharide or a polysaccharide. Examples of calorie-reduced, crystallization interfering agents (e.g., dietary fibers) include, but are not limited to, dextrin, maltodextrin, inulin, psyllium, beta-glucan, lignin, chitin, pectin, cellulose, methylcellulose, hemicellulose, galactomannan, resistant starch, arabinoxylan, glucomannan, and combinations thereof.

The sweetener material of a food (e.g., candy) product may comprise at least one sweetener carbohydrate and/or sweetener polyol, such as sucrose (e.g., as described herein). The sweetener material may comprise a carrier material (e.g., as described herein). The sweetener material may comprise a sweetener carbohydrate and/or sweetener polyol (e.g., sucrose) that has been homogenized with a carrier material (e.g., silica).

An interfering agent may be a material that is used to help prevent crystallization of a sweetener material during production of an amorphous food product. For example, an interfering agent may be added to a sweetener mixture (e.g., a mixture comprising a sweetener material and, in some cases, water and/or other components) prior to, during, or after heating of the sweetener mixture. The interfering agent may interfere with a developing sugar crystal structure to help ensure that the sugar molecules remain disordered.

An interfering agent may not have a dietary or nutritional value. In some cases, an interfering agent may have a lower relative sweetness than a sweetener material included in an amorphous food product. Examples of interfering agents include corn syrup and glucose syrup.

Glucose syrups are major ingredients in food products, particularly confections. In addition to the food value they provide, glucose syrups are used to control sweetness, texture, crystallization, browning, and humectancy. Because of the greater solubility of glucose syrups compared to sucrose, a mixture of sucrose and glucose syrup has a greater concentration than sucrose alone, with soluble solid concentrations of 75% and higher easily reached.

Lower dextrose equivalent (DE) glucose syrups, because of their greater percentage of long-chain residuals, increase the texture or body strength and are said to increase the ability to prevent crystallization. In the latter case, the long chain residuals are thought to prevent sucrose molecules from associating to form a crystal (Hartel, von Elbe and Hofberger, 2018).

This functionality makes glucose syrup an important ingredient in the manufacture of gelatin-based gummies and similar confections. They ensure that the product reaches the consumer in an optimal state in terms of texture. A grainy mouthfeel, resulting from the re-crystallization of the sucrose is highly not desirable, therefore dictating the use of glucose syrups to control and avoid this phenomenon.

The setting rates and physical properties of amorphous food products including amorphous candies are also dependent, to some extent, on the nature of the sweeteners used in the formulation. For example, sweeteners may impact gelation properties of gummy and jelly candies. Sucrose and corn/glucose syrup are the most common sweeteners used in gummy and jelly candies, but sugar-free versions based, for example, on maltitol, sorbitol, isomalt, and other hydrogenated starch hydrolysates (HSHs) can also be found

To make gummy and jelly candies, sugar (e.g., sucrose) and corn/glucose syrup are typically mixed with a gelling agent and heated to a set temperature to give the desired water content. A gelling agent may comprise, for example, starch, dextrin, milk proteins, a gelatin, pectin, agar, and a natural gum. For example, a gelling agent may comprise a gelatin, pectin, agar, and a natural gum.

Sucrose and glucose syrup form the bulk of most gummy and jelly candies. They provide sweetness and body in the form of a colored, flavored sugar syrup that is held in place by a gelling agent. Sucrose content is generally about 40-50% of the sweetener solids (dry basis) since these candies should not grain. In general, the high residual water content and high glucose content in gummies and jellies (15-20%) means that the sucrose remains completely solubilized and does not grain.

Glucose syrup generally makes up 50-60% of the sweetener solids (dry basis) used to prepare confections such as jelly and gummy candies. Typically, either 42 or 63 DE glucose syrup (or some combination) is used (Hartel, von Elbe and Hofberger, 2018).

The use of glucose syrups for the above-mentioned functionalities means that the overall sweetness of the products is not maximized, as the RS for the glucose is significantly lower than that of sucrose.

Today, and due to high obesity rates globally, and mainly among children, there is a clear need to reduce the amount of sugar ingested by the population. However, due to the natural preference of sweet foods, it is imperative to manage this property in foods targeted to children. When manufacturing sugar-reduced candies, the sugars content of the original product is often reduced. Lost bulk can be compensated for using “fillers” or bulking agents that often have lower caloric value and, in some cases, possible health benefits (e.g., dietary fibers) and/or contribution to sweetness. The sugars content is typically reduced equally for all sugar types, as a minimal amount of glucose syrup is needed to prevent crystallization. For example, if the sucrose is reduced by 40%, the glucose syrup will also be reduced by 40%.

We have discovered that a calorie-reduced, crystallization-interfering agent (e.g., a non-caloric, crystallization-interfering agent) such as a dietary fiber alone can take the role of glucose/corn syrup as the anti-crystallization agent. A significant part of the reduction of sweeteners can arise from a reduction in glucose/corn syrup, as it is no longer necessary as an anti-crystallization agent. This strategy has multiple benefits. For example, glucose syrup has a smaller contribution to sweetness than sucrose (relative sweetness (RS) of 0.3-0.7), while its caloric contribution is similar to sucrose on a by-weight basis. Therefore, when the overall sugar content is reduced by reducing the corn/glucose syrup only, the overall sweetness can be kept higher (in comparison to reducing both the sucrose and the corn/glucose syrup symmetrically). As another benefit, according to this scheme, the number of ingredients is the same as in the original product, as compared to other sugar reduction solutions, and therefore the production process is simpler, and the label is more consumer friendly. Further, by using sugars with higher relative sweetness than regular sucrose (e.g., a sweetener material comprising a carrier material, as described herein), the sweetness lost by removing the glucose syrup can be even further increased, leading to clear preference by consumers.

An interfering agent used in the production of an amorphous food product may be included in the amorphous food product. Alternatively or in addition, a derivative of an interfering agent (e.g., a residue or other material produced upon heating [melting] of the interfering agent) may be included in the amorphous food product. An interfering agent may be a caloric, crystallization-interfering agent. Such an agent may be, for example glucose syrup, corn syrup, honey, hydrogenated starch hydrolysate (HSH), or a combination thereof. A hydrogenated starch hydrolysate may be a polyol or combination of polyols produced by hydrogenating a saccharide product of starch hydrolysis. Examples of HSH include, but are not limited to, sorbitol, mannitol, and maltitol. An amorphous food product may include a caloric, crystallization-interfering agent and/or a derivative thereof. For example, the amorphous food product (e.g., candy product) may comprise less than about 60% of the caloric, crystallization-interfering agent and/or derivative thereof weight/weight (w/w) relative to the amorphous food product. An amorphous food product may comprise less than about 10% of a caloric, crystallization-interfering agent and/or derivative thereof weight/weight (w/w) relative to the amorphous food product, such as less than 7% w/w, less than 5% w/w, less than 4% w/w, less than 3% w/w, less than 2% w/w, or less than 1% w/w. In other cases, the amorphous food product may include no more than trace amounts of the caloric, crystallization-interfering agent and/or a derivative thereof. Such amorphous food products may be essentially free of the caloric, crystallization-interfering agent and/or derivative thereof.

Alternatively or in addition, an interfering agent may be a calorie-reduced, crystallization-interfering agent (e.g., a non-caloric, crystallization-interfering agent). A calorie-reduced, crystallization interfering agent may comprise, for example, a dietary fiber. Such materials may be substantially calorie-reduced, and may be substantially resistant to digestion in a human body (e.g., degradation by digestive enzymes). A calorie-reduced, crystallization-interfering agent may be, for example, selected from the group consisting of dextrin, maltodextrin, inulin, psyllium, beta-glucan, lignin, chitin, galactomannan, resistant starch, arabinoxylan, glucomannan, pectin, cellulose, methylcellulose, hemicellulose, and a combination thereof. An amorphous food product may comprise the calorie-reduced crystallization-interfering agent or derivative thereof at a concentration of at least 10% (w/w) relative to the amorphous food product, such as at least 12% w/w, at least 18% w/w, at least 20% w/w, at least 30% w/w, at least 40% w/w, or more.

An amorphous food product (e.g., candy product) of the present disclosure (e.g., an amorphous food product comprising a calorie-reduced, crystallization-interfering agent that may be a dietary fiber) may have a higher relative sweetness (RS) than a control amorphous food product (e.g., control candy product) without the calorie-reduced, crystallization-interfering agent (e.g., non-caloric, crystallization-interfering agent or dietary fiber).

An amorphous food product (e.g., candy product) may comprise one or more flavors, dyes (e.g., colors), or acids. For example, a food (e.g., candy) product may comprise citric acid. The citric acid may be incorporated within the food (e.g., candy) product or may be disposed on an exterior of the candy product. An amorphous food product (e.g., candy product) may comprise one or more incorporated elements, which incorporated elements are separate from the sweetener material. The one or more incorporated elements may comprise or be derived from nuts, seeds, cereals, confectionaries, chocolates, or fruits. For example, incorporated elements may include oats (e.g., rolled oats, steel cut oats, flaked oats, or oatmeal), rice (e.g., puffed rice or rice flakes), wheat (e.g., wheat berries, puffed wheat, or wheat germ), corn (e.g., popped corn, corn kernels, or corn flakes), chia seeds, quinoa, amaranth, buckwheat, bran, millet, barley, or chopped or whole nuts. Incorporated elements may be processed or unprocessed. Incorporated elements may be, for example, cooked, raw, toasted, shredded, crushed, hulled, chopped, whole, peeled, or unpeeled. The amorphous food product may also comprise one or more proteins, fats, or oils. Materials may be incorporated into an amorphous food product during preparation of the food product. For example, materials may be added to a sweetener mixture that has been heated and subsequently cooled (e.g., as described herein). Materials may be added to a sweetener mixture before completion of cooling. Materials may be added to a sweetener mixture before, after, or concurrently with other materials, such as with a gelling agent.

An amorphous food product (e.g., candy product) may be glassy or rubbery. An amorphous food product may have a soft, chewy, hard, or brittle texture.

For example, an amorphous food product (e.g., candy product) may have a soft and/or chewy texture. The product may comprise from about 10% to about 60% of the sweetener material (w/w) relative to the candy product, exclusive of any incorporated elements, such as from about 10%-20%, 10-30%, 10-40%, 10-50%, 20-30%, 20-40%, 20-50%, 30-40%, 30-50%, 40%-50%, or any range therein. The sweetener material may comprise a sweetener carbohydrate and/or polyol (e.g., sucrose) associated with a carrier material (e.g., silica), such as a sweetener carbohydrate that has been homogenized with a carrier material (e.g., as described herein). The ratio of sweetener material to the calorie-reduced, crystallization-interfering agent (e.g., non-caloric, crystallization-interfering agent or dietary fiber) and/or derivatives thereof in the amorphous food product (e.g., candy product) may be from 1:10 to 10:1, from 1:5 to 5:1, from 1:2 to 2:1, or from 1:1.5 to 1.5:1. The amorphous food product (e.g., candy product) may comprise at least about 10% water (w/w) relative to the composition, exclusive of any incorporated elements, such as at least about 15%, 20%, 25%, or more water. The amorphous food product (e.g., candy product) may comprise a gelling agent (e.g., as described herein). The amorphous food product (e.g., candy product) may be a gummy candy, jelly candy, cotton candy, or marshmallow candy. In other cases, the amorphous food product (e.g., candy product) may comprise protein and/or fat. Such materials may derive from, for example, egg whites or egg substitute incorporated into the amorphous food product (e.g., to make the product have an airy texture) or from milk fats (e.g., cream and butter) used to make the amorphous food product. Such an amorphous food product (e.g., candy product) may be a nougat, taffy, or caramel.

In another example, an amorphous food product (e.g., candy product) may have a hard or brittle texture. The amorphous food product (e.g., candy product) may comprise from about 10% to about 60% of the sweetener material (w/w) relative to the candy product, exclusive of any incorporated elements, such as about 10%-20%, 10-30%, 10-40%, 10-50%, 20-30%, 20-40%, 20-50%, 30-40%, 30-50%, 40%-50%, or any range therein. The sweetener material may comprise a sweetener carbohydrate and/or polyol (e.g., sucrose) associated with a carrier material (e.g., silica), such as a sweetener carbohydrate that has been homogenized with a carrier material (e.g., as described herein). The ratio of sweetener material to the calorie-reduced, crystallization-interfering agent (e.g., dietary fiber) and/or derivatives thereof in the amorphous food product (e.g., candy product) may be from about 1:10 to 10:1, from 1:5 to 5:1, from 1:2 to 2:1, or from 1:1.5 to 1.5:1. The amorphous food product (e.g., candy product) may comprise from about 0.1% to 20% water (w/w) relative to the composition, exclusive of any incorporated elements. In some cases, the amorphous food product (e.g., candy product) may consist essentially of the sweetener material and the calorie-reduced, crystallization-interfering agent (e.g., non-caloric, crystallization-interfering agent or dietary fiber) and/or derivatives thereof. Such an amorphous food product (e.g., candy product) may be a hard candy or pulled candy. In other cases, the amorphous food product (e.g., candy product) may comprise a protein, oil, lecithin, or fat. Such materials may derive from, for example, egg whites or egg substitute incorporated into the amorphous food product (e.g., to make the product have an airy texture) or from milk fats (e.g., cream and butter) used to make the amorphous food product. Such an amorphous food product (e.g., candy product) may be a brittle, such as a nut brittle.

In a related aspect, the present disclosure provides a composition comprising a (i) a sweetener material (e.g., as described herein) and (ii) at least one calorie-reduced, crystallization-interfering agent (e.g., non-caloric, crystallization-interfering agent or dietary fiber), or a derivative thereof. The sweetener material may comprise a sweetener carbohydrate and/or polyol (e.g., sucrose) associated with a carrier material (e.g., silica), such as a sweetener carbohydrate that has been homogenized with a carrier material (e.g., as described herein). The at least one calorie-reduced, crystallization-interfering agent, or the derivative thereof, may be present in an amount sufficient to at least partially prevent crystallization of the sweetener material (e.g., sucrose, such as sucrose associated with a carrier material, as described herein) in the composition under crystallizing conditions. Such crystallizing conditions may comprise elevated temperature and/or the sweetener material and the calorie-reduced, crystallization-interfering agent (e.g., dietary fiber) being present in a saturated or supersaturated aqueous solution. For example, crystallizing conditions may comprise a temperature elevated to or above the boiling point of water, such as between about 118-155° C. The syrup Brix may be about 85 and 86. This may be measured with a Brix meter. Following heating, the syrup may be cooled to at least about 65° C. (e.g., as described herein).

The composition may comprise less than about 60% of a caloric, crystallization-interfering agent (e.g., glucose syrup or corn syrup) and/or a derivative thereof weight/weight (w/w) relative to the composition. For example, the composition may comprise less than about 60% w/w, less than about 55% w/w, less than about 50% w/w, less than about 45% w/w, less than about 40% w/w, less than about 35% w/w, less than about 30% w/w, less than about 25% w/w, less than about 20% w/w, less than about 15% w/w, less than about 10% w/w, less than about 5% w/w, less than about 4% w/w, less than about 3% w/w, less than about 2% w/w, less than about 1% w/w, less than about 0.5% w/w, less than about 0.1% w/w, less than about 0.01% w/w, or less than about 0.001% w/w of a caloric, crystallization-interfering agent or a derivative thereof. The composition may have a higher relative sweetness than a control composition that comprises equal to or greater than about 50% of the caloric, crystallization-interfering agent and/or a derivative thereof (w/w) relative to the control composition. For example, the composition may have a higher relative sweetness than a control composition that comprises equal to or greater than about 5%, 10%, 15%, 20%, 25%, 30%, 35%, 40%, 45%, or 50% of the caloric, crystallization-interfering agent and/or a derivative thereof (w/w) relative to the control composition. The caloric, crystallization-interfering agent may be, for example, selected from the group consisting of glucose syrup, corn syrup, honey, hydrogenated starch hydrolysate, and a combination thereof. In some cases, the composition may be essentially free of a caloric, crystallization-interfering agent and/or a derivative thereof.

The sweetener material may comprise at least one sweetener carbohydrate or sweetener polyol. The sweetener material may comprise at least one sweetener carbohydrate that may be sucrose. In some cases, the sweetener material consists essentially of sucrose. The sweetener material may comprise a carrier material (e.g., silica) associated with the at least one sweetener carbohydrate. For example, the sweetener material may comprise about 0.001-4% carrier material weight/weight relative to the at least one sweetener carbohydrate. Additional details of sweetener materials are provided elsewhere herein.

The composition may comprise one or more flavors, colors/dyes, or acids. For example, the composition may comprise citric acid. The acid (e.g., citric acid) may be incorporated within the composition or may be disposed on an exterior of the composition. A composition may comprise one or more incorporated elements, which incorporated elements are separate from the sweetener material. The one or more incorporated elements may comprise or be derived from nuts, seeds, cereals, confectionaries, chocolates, or fruits. For example, incorporated elements may include oats (e.g., rolled oats, steel cut oats, flaked oats, or oatmeal), rice (e.g., puffed rice or rice flakes), wheat (e.g., wheat berries, puffed wheat, or wheat germ), corn (e.g., popped corn, corn kernels, or corn flakes), chia seeds, quinoa, amaranth, buckwheat, bran, millet, barley, or chopped or whole nuts. Incorporated elements may be processed or unprocessed. Incorporated elements may be, for example, cooked, raw, toasted, shredded, crushed, hulled, chopped, whole, peeled, or unpeeled. The composition may also comprise one or more proteins, fats, or oils. Incorporated elements, fats, proteins, oils, and/or other materials may be incorporated into a composition prior to a heating process, following a heating process (e.g., to a heated mixture), and/or to a cooled or cooling mixture. Materials may be incorporated at the same or different times (e.g., a first material may be added at a first time, such as during or prior to heating, and a second material may be added at a second time, such as during cooling).

The composition may comprise at least 10% of the at least one calorie-reduced, crystallization-interfering agent (e.g., dietary fiber) and/or the derivative thereof (w/w) relative to the composition, such as at least 20%, 30%, or more. As described above, the calorie-reduced, crystallization interfering agent (e.g., non-caloric, crystallization interfering agent or dietary fiber) may be soluble fiber, non-digestible fiber, insoluble fiber, or a combination thereof. The calorie-reduced, crystallization interfering agent (e.g., dietary fiber) may comprise an oligosaccharide or a polysaccharide. The calorie-reduced, crystallization interfering agent (e.g., dietary fiber) may be selected from the group consisting of dextrin, maltodextrin, inulin, psyllium, beta-glucan, lignin, chitin, galactomannan, resistant starch, arabinoxylan, glucomannan, pectin, cellulose, methylcellulose, hemicellulose, and a combination thereof.

The composition may be solid or semi-solid. The composition may be flexible or rigid. The composition may be a gummy or jelly. The composition may be amorphous at room temperature. For example, the composition may be rubbery or glassy. The composition may have a soft, chewy, hard, or brittle texture.

For example, a composition may have a soft or chewy texture. The product may comprise from about 10% to about 60% of the sweetener material (w/w) relative to the composition, exclusive of any incorporated elements. The sweetener material may comprise a sweetener carbohydrate and/or polyol (e.g., sucrose) associated with a carrier material (e.g., silica), such as a sweetener carbohydrate that has been homogenized with a carrier material (e.g., as described herein). The ratio of sweetener material to the calorie-reduced, crystallization-interfering agent (e.g., non-caloric, crystallization-interfering agent or dietary fiber) and/or derivatives thereof in the composition may be from about 1:10 to 10:1, from 1:5 to 5:1, from 1:2 to 2:1, or from 1:1.5 to 1.5:1. The composition may comprise at least about 10% water (w/w) relative to the composition, exclusive of any incorporated elements. The composition may comprise a gelling agent (e.g., as described herein). The composition may be a gummy candy, jelly candy, cotton candy, or marshmallow candy. In other cases, the composition may comprise protein, oil, lecithin, and/or fat. Such materials may derive from, for example, egg whites or egg substitute incorporated into the composition (e.g., to make the product have an airy texture) or from milk fats (e.g., cream and butter) used to make the composition. Such a composition (e.g., candy product) may be a nougat, taffy, or caramel.

In another example, a composition may have a hard or brittle texture. The composition may comprise about 10% to about 60% of the sweetener material (w/w) relative to the composition, exclusive of any incorporated elements. The sweetener material may comprise a sweetener carbohydrate and/or polyol (e.g., sucrose) associated with a carrier material (e.g., silica), such as a sweetener carbohydrate that has been homogenized with a carrier material (e.g., as described herein). The ratio of sweetener material to the calorie-reduced, crystallization-interfering agent (e.g., non-caloric, crystallization-interfering agent or dietary fiber) and/or derivatives thereof in the composition may be from about 1:10 to about 10:1, from about 1:5 to about 5:1, from about 1:2 to about 2:1, or from about 1:1.5 to about 1.5:1. The composition may comprise from about 0.1% to about 20% water (w/w) relative to the composition, exclusive of any incorporated elements. In some cases, the composition may consist essentially of the sweetener material and the calorie-reduced, crystallization-interfering agent (e.g., dietary fiber) and/or derivatives thereof. Such a composition may be a hard candy or pulled candy. In other cases, the composition may comprise a protein oil, lecithin, or fat. Such materials may derive from, for example, egg whites or egg substitute incorporated into the composition (e.g., to make the product have an airy texture) or from milk fats (e.g., cream and butter) used to make the composition. Such a composition may be a brittle, such as a nut brittle.

Methods of Making Amorphous Food Products

The present disclosure further provides methods of preparing consumable products. A method of preparing a consumable product (e.g., amorphous food products, such as amorphous candy products) may comprise combining a sweetener material (e.g., a sweetener material comprising sucrose, such as sucrose associated with a carrier material, as described herein) and a calorie-reduced, crystallization-interfering agent (e.g., non-caloric, crystallization-interfering agent or dietary fiber) to provide a sweetener mixture, wherein the calorie-reduced, crystallization-interfering agent is added in an amount sufficient to at least partially prevent crystallization of the sweetener material under crystallizing conditions. The crystallizing conditions may comprise elevated temperature (e.g., at or above the boiling point of water, such as between about 118-155° C. to provide a syrup Brix of about 85-86) and/or the sweetener mixture being included in a saturated or supersaturated solution. A method of preparing a consumable product may further comprise cooling a heated mixture. The consumable product may be or comprise an amorphous food product such as an amorphous candy product (e.g., as described herein).

The consumable product (e.g., food product, such as a candy product) may comprise less than about 60% (e.g., less than about 50%) of a caloric, crystallization-interfering agent (e.g., glucose syrup or corn syrup) weight/weight (w/w) relative to the consumable product. The consumable product may comprise less than about 20% of a caloric, crystallization-interfering agent weight/weight (w/w) relative to the consumable product. The consumable product may be essentially free of the caloric, crystallization-interfering agent. In some cases, the method does not comprise the use of a caloric, crystallization-interfering agent.

The caloric, crystallization-interfering agent may be selected from the group consisting of glucose syrup, corn syrup, honey, hydrogenated starch hydrolysate, and a combination thereof.

The sweetener mixture may be a syrup. The sweetener mixture may be a supersaturated solution.

The sweetener material may comprise at least one sweetener carbohydrate or sweetener polyol. The sweetener material may comprise at least one sweetener carbohydrate that may be sucrose. The sweetener material may consist essentially of sucrose. The sweetener material may comprise a carrier material associated with the at least one sweetener carbohydrate. For example, the sweetener material may comprise about 0.001-4% carrier material weight/weight relative to the at least one sweetener carbohydrate. Additional details of sweetener materials are provided elsewhere herein.

The method may involve adding one or more flavors, colors/dyes, or acids to the sweetener mixture. Such elements may be added before or after heating of a sweetener mixture. For example, citric acid may be incorporated within the sweetener mixture, or a consumable product may be coated in citric acid. The consumable product may comprise one or more incorporated elements, which incorporated elements are separate from the sweetener material. The one or more incorporated elements may comprise or be derived from nuts, seeds, cereals, confectionaries, chocolates, or fruits. For example, incorporated elements may include oats (e.g., rolled oats, steel cut oats, flaked oats, or oatmeal), rice (e.g., puffed rice or rice flakes), wheat (e.g., wheat berries, puffed wheat, or wheat germ), corn (e.g., popped corn, corn kernels, or corn flakes), chia seeds, quinoa, amaranth, buckwheat, bran, millet, barley, or chopped or whole nuts. Incorporated elements may be processed or unprocessed. Incorporated elements may be, for example, cooked, raw, toasted, shredded, crushed, hulled, chopped, whole, peeled, or unpeeled. The consumable product may also comprise one or more proteins, fats, or oils. Such materials may be incorporated into a consumable product during preparation of the consumable product. For example, some or all materials included in the consumable product may be added to the sweetener mixture, e.g., before or after heating.

The calorie-reduced, crystallization-interfering agent (e.g., non-caloric, crystallization-interfering agent or dietary fiber) may comprise soluble fiber, non-digestible fiber, or insoluble fiber. The calorie-reduced, crystallization-interfering agent (e.g., dietary fiber) may comprise an oligosaccharide or a polysaccharide. The calorie-reduced, crystallization-interfering agent (e.g., dietary fiber) may be selected from the group consisting of dextrin, maltodextrin, inulin, psyllium, beta-glucan, lignin, chitin, galactomannan, resistant starch, arabinoxylan, glucomannan, pectin, cellulose, methylcellulose, hemicellulose, and a combination thereof. The sweetener mixture may comprise at least about 10% of the calorie-reduced, crystallization-interfering agent (w/w) relative to the sweetener mixture.

The consumable product may be a solid or semi-solid composition. The consumable product may be flexible or rigid. The consumable product may be a gummy or jelly. The consumable product may be amorphous. The consumable product may be glassy or rubbery. The consumable product may have a soft, chewy, hard, or brittle texture.

In an example, the consumable product has a soft or chewy texture. The sweetener mixture may comprise between about 10-60% of the calorie-reduced, crystallization-interfering agent (e.g., non-caloric, crystallization-interfering agent or dietary fiber) (w/w) relative to the sweetener mixture, exclusive of any incorporated elements. The consumable product may comprise between about 20-50% of the calorie-reduced, crystallization-interfering agent weight/weight relative to the consumable product, exclusive of any incorporated elements. The sweetener mixture may comprise between about 10-60% sweetener material (e.g., sucrose, such as sucrose associated with a carrier material) (w/w) relative to the sweetener mixture, exclusive of any incorporated elements. The consumable product may comprise between about 20-50% sweetener material (w/w) relative to the consumable product, exclusive of any incorporated elements. The sweetener material may comprise a sweetener carbohydrate and/or polyol (e.g., sucrose) associated with a carrier material (e.g., silica), such as a sweetener carbohydrate that has been homogenized with a carrier material (e.g., as described herein). The consumable product may comprise a higher percentage by weight of a dietary fiber than of the sweetener material. The consumable product may comprise about the same percentage by weight of a dietary fiber and of the sweetener material. The method of making the consumable product may comprise heating the sweetener mixture to provide a heated sweetener mixture. The sweetener mixture may be heated to between about 118-155° C. The syrup Brix may be about 85 and 86. This may be measured with a Brix meter. The method of making the consumable product may comprise cooling the sweetener mixture. Cooling the heated sweetener mixture may comprise subjecting the heated sweetener mixture to a controlled cooling process. Alternatively or in addition, cooling the heated sweetener mixture may comprise depositing the heated sweetener mixture onto a cooling table or into molds. For example, a syrup may be cooled to at least about 65° C. following heating. The consumable product may comprise at least about 10% of the water (w/w) relative to the consumable product, exclusive of any incorporated elements. The method of making the consumable product may comprise adding a gelling agent (e.g., as described herein) to the sweetener mixture (e.g., before or after heating and/or cooling the sweetener mixture). The consumable product may be a gummy candy, jelly candy, cotton candy, or marshmallow candy. The consumable product may further comprise protein, fat, oil, or combination thereof, exclusive of any incorporated elements. Such a consumable product may be, for example, a nougat, taffy, or caramel.

In another example, the consumable product has a hard or brittle texture. The sweetener mixture may comprise between about 10-60% of the calorie-reduced, crystallization-interfering agent (e.g., non-caloric, crystallization-interfering agent or dietary fiber) weight/weight relative to the sweetener mixture, exclusive of any incorporated elements. The consumable product may comprise between about 20-50% of the calorie-reduced, crystallization-interfering agent (w/w) relative to the consumable product, exclusive of any incorporated elements. The sweetener mixture may comprise between about 10-60% sweetener material (e.g., sucrose, such as sucrose associated with a carrier material) (w/w) relative to the sweetener mixture, exclusive of any incorporated elements. The consumable product may comprise between about 20-50% sweetener material (w/w) relative to the consumable product, exclusive of any incorporated elements. The sweetener material may comprise a sweetener carbohydrate and/or polyol (e.g., sucrose) associated with a carrier material (e.g., silica), such as a sweetener carbohydrate that has been homogenized with a carrier material (e.g., as described herein). The consumable product may comprise a higher percentage by weight of a dietary fiber than of the sweetener material. The consumable product may comprise about the same percentage by weight of a dietary fiber and of the sweetener material. The method of making the consumable product may further comprise heating the sweetener mixture to provide a heated sweetener mixture. The sweetener mixture may be heated to between about 118-155° C. The syrup Brix may be about 85 and 86. The method of making the consumable product may further comprise cooling the heated sweetener mixture. Cooling the heated sweetener mixture may comprise subjecting the heated sweetener mixture to a controlled cooling process, and/or depositing the heated sweetener mixture onto a cooling table or into molds. For example, a syrup may be cooled to at least about 65° C. following heating. The consumable product may comprise less than about 0.1-20% of the water (w/w) relative to the consumable product, exclusive of any incorporated elements. The consumable product may consist essentially of the sweetener material and the calorie-reduced, crystallization-interfering agent (e.g., dietary fiber). The consumable product may be a hard candy or pulled candy. The consumable product may comprise protein, fat, oil, or combination thereof, exclusive of any incorporated elements. Such a consumable product may be a brittle.

In a further aspect, the present disclosure provides a method of preparing a consumable product (e.g., a food product such as a candy product) that may comprise combining a sweetener material (e.g., sucrose, such as sucrose associated with a carrier material) and an interfering agent to provide a sweetener mixture, wherein the interfering agent is (i) a calorie-reduced, crystallization-interfering agent (e.g., non-caloric, crystallization-interfering agent or dietary fiber) or (ii) a combination of a caloric, crystallization-interfering agent (e.g., glucose syrup or corn syrup) and a calorie-reduced, crystallization-interfering agent (e.g., dietary fiber), wherein the sweetener mixture comprises less than about 60% (e.g., less than about 50%) of the caloric, crystallization-interfering agent, and wherein the consumable product is amorphous at room temperature.

The sweetener mixture may comprise less than about 20% of the caloric, crystallization-interfering agent. The consumable product may be essentially free of the caloric, crystallization-interfering agent. The method may not comprise the use of a caloric, crystallization-interfering agent.

The caloric, crystallization-interfering agent may be selected from the group consisting of glucose syrup, corn syrup, honey, hydrogenated starch hydrolysate, and a combination thereof.

The sweetener mixture may be a syrup. The sweetener mixture may be a supersaturated solution.

The sweetener material may comprise at least one sweetener carbohydrate or sweetener polyol. The sweetener material may comprise at least one sweetener carbohydrate that may be sucrose. The sweetener material may consist essentially of sucrose. The sweetener material may comprise a carrier material (e.g., silica) associated with the at least one sweetener carbohydrate (e.g., sucrose). For example, the sweetener material may comprise about 0.001-4% carrier material weight/weight relative to the at least one sweetener carbohydrate. Additional details of sweetener materials are provided elsewhere herein.

The method may involve adding one or more flavors, colors/dyes, or acids to the sweetener mixture. Such elements may be added before or after heating of a sweetener mixture. For example, citric acid may be incorporated within the sweetener mixture, or a consumable product may be coated in citric acid. The consumable product may comprise one or more incorporated elements, which incorporated elements are separate from the sweetener material. The one or more incorporated elements may comprise or be derived from, for example, nuts, seeds, cereals, confectionaries, chocolates, or fruits. For example, incorporated elements may include oats (e.g., rolled oats, steel cut oats, flaked oats, or oatmeal), rice (e.g., puffed rice or rice flakes), wheat (e.g., wheat berries, puffed wheat, or wheat germ), corn (e.g., popped corn, corn kernels, or corn flakes), chia seeds, quinoa, amaranth, buckwheat, bran, millet, barley, or chopped or whole nuts. Incorporated elements may be processed or unprocessed. Incorporated elements may be, for example, cooked, raw, toasted, shredded, crushed, hulled, chopped, whole, peeled, or unpeeled. The consumable product may also comprise one or more proteins, fats, or oils. Materials may be incorporated into a consumable product at any useful time. For example, materials may be added to a sweetener mixture that has been heated and subsequently cooled (e.g., as described herein). Materials may be added to a sweetener mixture before completion of cooling. Materials may be added to a sweetener mixture before, after, or concurrently with other materials, such as with a gelling agent.

The calorie-reduced, crystallization-interfering agent (e.g., non-caloric, crystallization-interfering agent or dietary fiber) may comprise soluble fiber, non-digestible fiber, or insoluble fiber. The calorie-reduced, crystallization-interfering agent (e.g., dietary fiber) may comprise an oligosaccharide or a polysaccharide. The calorie-reduced, crystallization-interfering agent (e.g., dietary fiber) may be selected from the group consisting of dextrin, maltodextrin, inulin, psyllium, beta-glucan, lignin, chitin, galactomannan, resistant starch, arabinoxylan, glucomannan, pectin, cellulose, methylcellulose, hemicellulose, and a combination thereof. The sweetener mixture may comprise at least about 10% of the calorie-reduced, crystallization-interfering agent (e.g., dietary fiber) (w/w) relative to the sweetener mixture.

The consumable product may be a solid or semi-solid composition. The consumable product may be flexible or rigid. The consumable product may be a gummy or jelly. The consumable product may be amorphous. The consumable product may be glassy or rubbery. The consumable product may have a chewy, hard, or brittle texture.

In an example, the consumable product (e.g., food product, such as a candy product) has a soft or chewy texture. The sweetener mixture may comprise between about 10-60% of the calorie-reduced, crystallization-interfering agent (e.g., non-caloric, crystallization-interfering agent or dietary fiber) (w/w) relative to the sweetener mixture, exclusive of any incorporated elements. The consumable product may comprise between about 20-50% of the calorie-reduced, crystallization-interfering agent (e.g., dietary fiber) weight/weight relative to the consumable product, exclusive of any incorporated elements. The sweetener mixture may comprise between about 10-60% sweetener material (e.g., sucrose, such as sucrose associated with a carrier material) (w/w) relative to the sweetener mixture, exclusive of any incorporated elements. The consumable product may comprise between about 20-50% sweetener material (w/w) relative to the consumable product, exclusive of any incorporated elements. The sweetener material may comprise a sweetener carbohydrate and/or polyol (e.g., sucrose) associated with a carrier material (e.g., silica), such as a sweetener carbohydrate that has been homogenized with a carrier material (e.g., as described herein). The consumable product may comprise a higher percentage by weight of a dietary fiber than of the sweetener material. The consumable product may comprise about the same percentage by weight of a dietary fiber and of the sweetener material. The method of making the consumable product may comprise heating the sweetener mixture to provide a heated sweetener mixture. The sweetener mixture may be heated to between about 118-155° C. The syrup Brix may be about 85 and 86. The method of making the consumable product may comprise cooling the sweetener mixture. Cooling the heated sweetener mixture may comprise subjecting the heated sweetener mixture to a controlled cooling process. Alternatively or in addition, cooling the heated sweetener mixture may comprise depositing the heated sweetener mixture onto a cooling table or into molds. For example, a syrup may be cooled to at least 65° C. following heating. The consumable product may comprise at least 10% of the water (w/w) relative to the consumable product, exclusive of any incorporated elements. The method of making the consumable product may comprise adding a gelling agent (e.g., as described herein) to the sweetener mixture (e.g., before or after heating and/or cooling the sweetener mixture). The consumable product may be a gummy candy, jelly candy, cotton candy, or marshmallow candy. The consumable product may further comprise protein, fat, oil, or combination thereof, exclusive of any incorporated elements. Such a consumable product may be, for example, a nougat, taffy, or caramel.

In another example, the consumable product (e.g., food product, such as a candy product) has a hard or brittle texture. The sweetener mixture may comprise between about 10-60% of the calorie-reduced, crystallization-interfering agent (e.g., non-caloric, crystallization-interfering agent or dietary fiber) weight/weight relative to the sweetener mixture, exclusive of any incorporated elements. The consumable product may comprise between about 20-50% of the calorie-reduced, crystallization-interfering agent (w/w) relative to the consumable product, exclusive of any incorporated elements. The sweetener mixture may comprise between about 10-60% sweetener material (e.g., sucrose, such as sucrose associated with a carrier material) (w/w) relative to the sweetener mixture, exclusive of any incorporated elements. The consumable product may comprise between about 20-50% sweetener material (w/w) relative to the consumable product, exclusive of any incorporated elements. The sweetener material may comprise a sweetener carbohydrate and/or polyol (e.g., sucrose) associated with a carrier material (e.g., silica), such as a sweetener carbohydrate that has been homogenized with a carrier material (e.g., as described herein). The consumable product may comprise a higher percentage by weight of a dietary fiber than of the sweetener material. The consumable product may comprise about the same percentage by weight of a dietary fiber and of the sweetener material. The method of making the consumable product may further comprise heating the sweetener mixture to provide a heated sweetener mixture. The sweetener mixture may be heated to between about 118-155° C. The syrup Brix may be about 85 and 86. The method of making the consumable product may further comprise cooling the heated sweetener mixture. Cooling the heated sweetener mixture may comprise subjecting the heated sweetener mixture to a controlled cooling process, and/or depositing the heated sweetener mixture onto a cooling table or into molds. For example, a syrup may be cooled to at least about 65° C. following heating. The consumable product may comprise less than about 0.1-20% of the water (w/w) relative to the consumable product, exclusive of any incorporated elements. The consumable product may consist essentially of the sweetener material and the calorie-reduced, crystallization-interfering agent (e.g., dietary fiber). The consumable product may be a hard candy or pulled candy. The consumable product may comprise protein, fat, or combination thereof, exclusive of any incorporated elements. Such a consumable product may be a brittle.

### Sweetener Material

The sweetener material of a candy product may comprise at least one sweetener carbohydrate and/or sweetener polyol. The sweetener material may comprise at least one sweetener carbohydrate and may not comprise a sweetener polyol. The at least one sweetener carbohydrate may be sucrose. The sweetener material may consist essentially of sucrose, such as sucrose associated with a carrier material (e.g., as described herein). The sweetener material may comprise a plurality of sweetener carbohydrates and/or polyols, such as a plurality of sweetener carbohydrates and/or polyols associated with the carrier material. Examples of sweetener carbohydrates include, but are not limited to, sucrose, glucose, maltose, lactose, high fructose corn syrup, high maltose corn syrup, and combinations thereof. Examples of sweetener polyols include, but are not limited to, xylitol, maltitol, erythritol, sorbitol, threitol, arabitol, hydrogenated starch hydrolysate, isomalt, lactitol, mannitol, galactitol (dulcitol), and combinations thereof.

A sweetener material may comprise a carrier material associated (e.g., non-covalently associated) with the at least one sweetener carbohydrate and/or polyol of the sweetener material (e.g., sucrose). The carrier material may be, for example, silica (e.g., precipitated silica or silica gel). Alternatively, the carrier material may be cellulose. The sweetener material may comprise about 0.001-4% carrier material weight/weight relative to the sweetener material. The sweetener composition may comprise about 0.05-4% carrier material weight/weight relative to the sweetener material. The sweetener composition may comprise about 0.01-2% carrier material weight/weight relative to the sweetener material. The sweetener composition may comprise about 0.01-0.5% carrier material weight/weight relative to the sweetener material.

A carrier material may be distributed throughout the sweetener material. In some cases, the sweetener material and carrier material are included in a composition as a plurality of particles comprising the sweetener material and the carrier material. For example, the sweetener material and carrier material may be included in a composition as a plurality of particles coated partially or completely with the sweetener material. The plurality of particles may be a plurality of nanoparticles.

A sweetener material comprising a carrier material (e.g., as described herein) may have enhanced sweetness compared to a control composition, which control composition consists of the same contents by identity and quantity as the sweetener composition but without the carrier material.

A sweetener material comprising a sweetener carbohydrate associated with a carrier material may be prepared according to any useful method. In an example, a sweetener material associated with a carrier material may be prepared by (i) mixing the carrier material with a syrup comprising a sweetener carbohydrate and/or polyol to form a substantially uniform dispersion, wherein the syrup comprises a solvent and the sweetener carbohydrate and/or polyol; and (ii) sonicating the dispersion to associate the sweetener carbohydrate and/or polyol with the carrier material to form the sweetener material. The mixture including the carrier material and the sweetener carbohydrate and/or polyol may comprise at least 15% by weight water, and from about 10% to 70% by combined weight of the carrier material and the sweetener carbohydrate and/or polyol. The solvent may be mixed with the sweetener material to form the syrup. The solvent may be water. The sweetener material may comprise a plurality of sweetener carbohydrates and/or polyols, such as a plurality of sweetener carbohydrates and/or polyols associated with the carrier material.

In another example, a sweetener material associated with a carrier material may be prepared by (i) adding the carrier material to a syrup comprising a solvent and a sweetener carbohydrate and/or polyol to form a sweetener composition; and (ii) dispersing the carrier material within the sweetener composition, wherein dispersing the carrier material comprises homogenizing the sweetener composition. Homogenizing the sweetener composition may be performed using high shear homogenization, high pressure homogenization, or a microfluidizer. The sweetener material may comprise a plurality of sweetener carbohydrates and/or polyols, such as a plurality of sweetener carbohydrates and/or polyols associated with the carrier material.

In another example, a sweetener material associated with a carrier material may be prepared by mixing a sweetener carbohydrate and/or polyol with a carrier material precursor and a catalyst, co-reagent, or acid such that a reaction between the carrier material precursor and the catalyst, co-reagent, or acid occurs in the presence of the sweetener carbohydrate and/or polyol to form the sweetener material. The catalyst may be ion exchange resin or ion exchange polymer. The acid may be, for example, acetic acid, aconitic acid, adipic acid, alginic acid, ascorbic acid, benzoic acid, caprylic acid, carbonic acid, citric acid, fumaric acid, hydrochloric acid, lactic acid, linoleic acid, malic acid, phosphoric acid, propionic acid, quinic acid, salicylic acid, sorbic acid, stearic acid, succinic acid, sulfuric acid, tannic acid, tartaric acid, vinegar, a dairy product, milk, condensed milk, cream, buttermilk, yogurt, fruit juice, fruit juice concentrate, nectar, vegetable juice, or any combination thereof. The sweetener material may comprise a plurality of sweetener carbohydrates and/or polyols, such as a plurality of sweetener carbohydrates and/or polyols associated with the carrier material.

Preparing a sweetener material comprising a sweetener carbohydrate and/or polyol associated with a carrier material may further comprise sonicating or homogenizing a sweetener composition comprising the carrier material and the sweetener carbohydrate and/or polyol. Preparing a sweetener material comprising a sweetener carbohydrate and/or polyol associated with a carrier material may further comprise passing a sweetener composition comprising the carrier material and the sweetener carbohydrate and/or polyol through a sieve or sieving tower.

### Example 1: Preparation of a Gummy Candy

Gummy candies including are prepared according to the methods provided herein. Gummy candies are prepared using sucrose or sucrose associated with a carrier material (e.g., as described herein) using the ratios provided in Table 1.

TABLE 1
Preparation of a sugar-reduced gummy candy.

| | | | Gummy Candy with | |
|---|---|---|---|---|
| | Gummy Candy | | carrier material | |
| Ingredients | g | % | g | % |
| Glucose syrup 65 Bx | 144.0 | 36.0 | 144.0 | 36.0 |
| Sucrose | 0.0 | 0.0 | 144.0 | 36.0 |
| Sucrose associated | 144.0 | 36.0 | 0 | 0 |
| with carrier | | | | |
| Water 1 | 28 | 7.0 | 28 | 7.0 |
| Orafti ® HSI Inulin (By Beneo) | 0.0 | 0.0 | 0.0 | 0.0 |
| Total syrup mix | 316.0 | | 316.0 | |
| Water 2 (30-40° C.) | 46 | 11.5 | 46 | 11.5 |
| Beef Gelatin 240 bloom | 24 | 6.0 | 24 | 6.0 |
| Citric acid powder | 1.2 | 0.3 | | 0.3 |
| Orange Flavor | 0.32 | 0.08 | 0.24 | 0.06 |
| Curcumin 7% | 0.28 | 0.07 | 0.28 | 0.07 |
| Water 3 | 12.0 | 3.0 | 12.0 | 3.0 |
| Total | 400 | 100 | 399 | 100 |

The sweetness of the gummy candy made with sucrose and the gummy candy made with sucrose associated with a carrier material are evaluated. As shown in Table 2 below, the gummy candy made with sucrose associated with a carrier material is rated sweeter in a taste test than the gummy candy made with sucrose by 12 tasters. Accordingly, sucrose associated with a carrier material successfully increases the sweetness of a candy product compared to sucrose without a carrier material.

TABLE 2
Taste test of gummy candies.

Best tasting gummy candy?

| | | Gummy Candy with |
|---|---|---|
| Taster | Gummy Candy | carrier material |
| TOTAL | 3 | 9 |
| % | 25 | 75 |

### Example 2: Preparation of a Gummy Candy

Sugar-reduced gummy candies are prepared according to the methods provided herein. Control gummy candies are also prepared. The ingredients listed in the table below are used to prepare sugar-reduced gummy candies including Sucrose associated with silica (DouxMatok Incredo sugar) (e.g., as described herein), a control gummy candy including with a reduced amount of sucrose, and a control gummy candy including with more sucrose.

TABLE 3
Preparation of sugar-reduced gummy candies.

| | Gummy Candy | Gummy Candy | Sugar- | Sugar- |
|---|---|---|---|---|
| | Prepared with | Prepared with | Reduced | Reduced |
| | Full Sugar | Reduced Sugar | Gummy | Gummy |
| Ingredients | (Control) | (Control) | Candy 1 | Candy 2 |
| Glucose syrup (80%) | 52.00 | | | |
| Sucrose | 26.00 | 25.00 | | |
| Sucrose associated with | | | 25.00 | 25.00 |
| silica (DouxMatok | | | | |
| Incredo sugar) | | | | |
| Water 1 | 9.00 | 23.00 | 23.00 | 23.00 |
| Citric acid (50% | 1.00 | 1.00 | 1.00 | 1.00 |
| solution) | | | | |
| Maltodextrin | | | | |
| Orafti ® HSI Inulin (By | | 38.00 | 38..00 | 38.00 |
| Beneo) | | | | |
| Water 2 | 14.00 | 14.00 | 14.00 | 14.00 |
| Beef Gelatin 240 bloom | 6.00 | 6.00 | 6.00 | 6.00 |
| Orange Flavor | | | | |
| Sunset Yellow Color | | | | |
| (10%) | | | | |
| Total | 108.0 | 107.0 | 107.0 | 107.0 |
| Sugar content | 44.3 | 28.2 | 28.2 | 28.2 |
| Sugar reduction | 0% | 36% | 36% | 36% |

### Example 3: Preparation of Candy Products

Candy products (e.g., gummies) are prepared in a tank having a minimum capacity of 10 kg. A gelatin premix is made by combining gelatin with water in a bath to 60° C. Dry materials including sweetener materials (e.g., as described herein) are premixed and combined with water to form a slurry. The slurry is cooked on a flame to 60° C. Premixing may facilitate dissolution of various dry powders. When preparing products having reduced sugar, only 30% of a reduced sugar material (e.g., 700 g/2400 g) (e.g., a material comprising a sweetener component and a carrier material such as silica, as described herein) may be included in a premixture of dry materials, and the remainder of the reduced sugar material may be added before heating the slurry. The heated slurry and the gelatin premix are combined. The combined mixture is inserted into the tank for heating to about 105° C., optionally without boiling and with high pressure. The slurry is cooled, optionally in a vacuum chamber, to about 80° C. Sugar content is then measured (e.g., in Brix, Bx). Sugar content may be between 77-78 Bx, for example. Additives such as flavor, acid, and color (dye) are added to the mixture or a portion of the mixture, such as to about 3 kg of the mixture. Samples are dried, optionally on starch trays within molds, for drying 24 or more hours. Samples are deposited, waxed, and rested for two or more days. Clarity, texture, and water content of candy products may be measured. Candy products (e.g., gummies) prepared according to the preceding methods may have greater clarity than samples prepared according to other methods.

Preparation of a control gummy candy is carried out according to the recipe in Table 4 and the methods provided above. Table 5 shows the same ratios in grams.

TABLE 4
Preparation of gummy candies.

| | | | Sugar- | Sugar- |
|---|---|---|---|---|
| | | Sugar- | reduced | reduced |
| | Full | reduced | preparation | preparation |
| | sugar | preparation | with carrier | with carrier |
| Ingredients | (%) | (%) | (v1) (%) | (v2) (%) |
| Glucose syrup | 52.00 | | | |
| (80%) | | | | |
| Sucrose | 26.00 | 25.00 | | |
| Sucrose associated | | | 25.00 | 25.00 |
| with carrier | | | | |
| Water 1 | 9.00 | 23.00 | 23.00 | 23.00 |
| Citric acid (50% | 1.00 | 1.00 | 1.00 | 1.00 |
| solution) | | | | |
| Maltodextrin | | 13.00 | 13.00 | 13.00 |
| Inulin HSI by Beneo | | 25.00 | 25.00 | 25.00 |
| Orafti | | | | |
| Water 2 | 14.00 | 14.00 | 14.00 | 14.00 |
| Beef Gelatin 240 | 6.00 | 6.00 | 6.00 | 6.00 |
| bloom | | | | |
| Orange flavor | 1.30 | 1.30 | 1.30 | 1.30 |
| Sunset Yellow | 0.13 | 0.13 | 0.13 | 0.13 |
| (10%) | | | | |
| Total | 109.4 | 108.4 | 108.4 | 108.4 |
| Total | 109 | 108 | 108 | 108 |
| Sugar content | 44.3 | 28.2 | 28.2 | 28.2 |
| Sugar reduction | 0% | 36% | 36% | 36% |

TABLE 5
Preparation of a gummy candies.

| | | | Sugar- | Sugar- |
|---|---|---|---|---|
| | | Sugar- | reduced | reduced |
| | Full | reduced | preparation | preparation |
| | sugar | preparation | with carrier | with carrier |
| Ingredients | (g) | (g) | (v1) (g) | (v2) (g) |
| Glucose syrup | 4752 | | | |
| (80%) | | | | |
| Sucrose | 2376 | 2306 | | |
| Sucrose associated | | | 2306 | 2306 |
| with carrier | | | | |
| Water 1 | 822 | 2121 | 2121 | 2121 |
| Citric acid (50% | 92 | 92 | 92.2 | 92.2 |
| solution) | | | | |
| Maltodextrin | | 1199 | 1199 | 1199 |
| Inulin HSI by Beneo | | 2306 | 2306 | 2306 |
| Orafti | | | | |
| Water 2 | 1291 | 1291 | 1291 | 1291 |
| Beef Gelatin 240 | 548 | 553 | 553 | 553 |
| bloom | | | | |
| Orange flavor | 120 | 120 | 119.77 | 119.77 |
| Sunset Yellow | 12 | 12 | 11.98 | 11.98 |
| (10%) | | | | |
| Total | 10014 | 10000 | 10000 | 10000 |

### Example 4: Preparation of Gummy Candies

Gummy candies are prepared according to the protocol in Example 3. Table 6 provides recipes used in the preparation of gummy candies in percentages, while Table 7 provides the same recipes in grams. Fillers may include maltodextrin and inulin.

TABLE 6
Preparation of sugar-reduced gummy candies.

| | | Sugar- | |
|---|---|---|---|
| | Gummy Candy | Reduced | Sugar- |
| | Prepared with | Gummy | Reduced |
| | Full Sugar | Candy | Gummy |
| | (Control) | (Control) | Candy |
| Ingredients | (%) | (%) | (%) |
| Glucose syrup (80%) | 48.50 | | |
| Sucrose | 24.00 | 25.00 | |
| Sucrose associated with | | | 25.00 |
| silica (DouxMatok | | | |
| Incredo sugar) | | | |
| Water 1 | 8.00 | 18.60 | 18.60 |
| Maltodextrin | | 36.90 | 36.90 |
| Water 2 | 13.00 | 13.00 | 13.00 |
| Beef Gelatin 240 bloom | 5.60 | 5.60 | 5.60 |
| Flavor | 0.30 | 0.30 | 0.30 |
| Color | 0.10 | 0.10 | 0.10 |
| Citric Acid | 0.50 | 0.50 | 0.50 |
| Total | 100.0 | 100.0 | 100.0 |
| Sugar content | 45.0 | 26.1 | 26.1 |
| Sugar reduction | 0% | 42% | 42% |

TABLE 7
Preparation of sugar-reduced gummy candies.

| | | Sugar- | |
|---|---|---|---|
| | Gummy Candy | Reduced | Sugar- |
| | Prepared with | Gummy | Reduced |
| | Full Sugar | Candy | Gummy |
| | (Control) | (Control) | Candy |
| Ingredients | (g) | (g) | (g) |
| Glucose syrup (80%) | 485 | 0 | 0 |
| Sucrose | 240 | 250 | 0 |
| Sucrose associated with | 0 | 0 | 250 |
| silica (DouxMatok | | | |
| Incredo sugar) | | | |
| Water 1 | 80 | 186 | 186 |
| Maltodextrin | 0 | 369 | 369 |
| Water 2 | 130 | 130 | 130 |
| Beef Gelatin 240 bloom | 56 | 56 | 56 |
| Flavor | 3 | 3 | 3.00 |
| Color | 1 | 1 | 0.96 |
| Citric Acid | 5 | 5 | 5.00 |
| Total | 1000 | 1000 | 1000 |

Reduced-sugar gummy candies prepared using sucrose and Sucrose associated with silica (DouxMatok Incredo sugar) have 40% less sugar than the full sugar control. The effective reduction of relative sweetness, accounting for Brix and dextrose equivalent measures, is 43.3.

### Example 5: Taste Test of Gummy Candies

A taste test of gummy candies prepared according to Table 6 is carried out for 27 tasters. As shown in the table below, sugar-reduced gummy candies are rated sweeter in a taste test than control gummy candies. The reduced sugar candy includes Orafti Inulin HSI and maltodextrin.

TABLE 8
Taste test of sugar-reduced gummy candies.

Best Tasting Gummy Candy?

| | | Sugar-Reduced Gummy Candy |
|---|---|---|
| | Gummy Candy | including sweetener |
| | Prepared with Full | material associated |
| Taster | Sugar (Control) | with carrier material |
| TOTAL | 7 | 20 |
| % | 26 | 74 |

A further taste test of the gummy candies according to Tables 4 and 5 is also performed.

TABLE 9
Taste test of sugar-reduced gummy candies.

| | Best Tasting Gummy Candy? | | |
|---|---|---|---|
| | | | Sugar-Reduced |
| | Gummy Candy | | Gummy Candy |
| | Prepared with | Sugar-Reduced | including sweetener |
| | Full Sugar | Gummy Candy | material associated |
| Taster | (Control) | (Control) | with carrier material |
| Mean | 5 | 4.04 | 4.67 |
| SD | 0 | 1.16 | 1.39 |

### Example 6: Preparation of Cereal Bars

Various consumable (e.g., food) products comprising sweeteners may be prepared according to the methods provided herein. For example, products prepared using amorphous sweetener syrups, including cereal and granola bars, may be prepared according to the methods provided herein. In such products, a syrup may act as a glue that binds various incorporated elements such as nuts, seeds, cereals, confectionaries, chocolates, or fruits.

Cereal bars are prepared by preparing a sweetener syrup and mixing various materials into the syrup (e.g., heated syrup, cooling syrup, and/or cooled syrup). The resultant mixture is placed in trays or molds to cool and/or set. Cereal bars are baked (e.g., in trays or molds).

Crispy, baked cereal bars are prepared according to the recipe in Table 10.

TABLE 10
Preparation of baked cereal bars.

| | Cereal Bars prepared | | Sugar-Reduced Cereal Bars | |
|---|---|---|---|---|
| Ingredients | with Full Sugar | | (sugar reduced by 40%) | |
| Sweetener | Glucose syrup | 14.9% | Sucrose associated | 19.37% |
| | Sucrose | 24.9% | with silica | |
| Water | Water | 4.15% | Water | 8.1% |
| Oil | Sunflower oil | 4.15% | Sunflower oil | 4.15% |
| Fillers | | | Orafti L92 | 5.07% |
| | | | Promitor | 11.41% |
| Flavor | Vanilla flavor | 0.15% | Vanilla flavor | 0.15% |
| Other | Lecithin | 0.15% | Lecithin | 0.15% |
| Elements | Oats | 22.9% | Oats | 22.9% |
| | Rice flakes | 14.9% | Rice flakes | 14.9% |
| | Corn flakes | 13.8% | Corn flakes | 13.8% |

Oats are roasted for 10 minutes at 140° C. For control bars, glucose, sucrose, water, oil, vanilla, and lecithin are heated in a ThermoMix to 110° C. on speed 2.5 and cooked for 1.5 minutes after achieving temperature. For reduced sugar bars, a reduced sugar component, water, oil, vanilla, and fillers are heated in a ThermoMix to 110° C. on speed 2.5 and cooked for 1.5 minutes after achieving temperature. The resultant mixtures are poured into a 1 centimeter (cm) form and flattened. The forms including the mixtures are baked for 5 minutes at 135° C. and then cooled and cut to size.

Chewy, non-baked cereal bars are prepared according to the recipe in Table 11.

TABLE 11
Preparation of non-baked cereal bars.

| | Cereal Bars prepared | | Sugar-Reduced Cereal Bars | |
|---|---|---|---|---|
| Ingredients | with Full Sugar | | (sugar reduced by 40%) | |
| Sweetener | Glucose syrup | 20% | Sucrose associated | 6.8% |
| | Sucrose | 10% | with silica | |
| Water | Water | 10% | Water | 9% |
| Oil | Canola oil | 2% | Canola oil | 2% |
| Gelling Agent | Gum acacia | 1% | Gum acacia | 1% |
| | Glycerol | 4% | Glycerol | 2% |
| Fillers | | | Fibruline S30 | 3.2% |
| | | | Orafti L95 | 20% |
| Other | Cereal | 41% | Cereal | 43% |
| Elements | Chopped | 12% | Chopped | 13% |
| | hazelnuts | | hazelnuts | |

For control bars, glucose, sucrose, water, oil, gum acacia, and glycerol are heated in a ThermoMix to 112° C. on speed 2.5 and cooked until a ° Bx of 84±2 is reached. For reduced sugar bars, a reduced sugar component, water, oil, gum acacia, glycerol, and fillers are heated in a ThermoMix to 112° C. on speed 2.5 and cooked until a ° Bx of 84±2 is reached. The resultant slurries are mixed in a mixer with cereal and nuts at speed 2 for about 30 seconds. The resultant mixtures are then poured onto lined baking sheets with guides of 2 centimeters, flattened, and refrigerated for at least 2 hours. Cereal bars are subsequently cut into consumable units.

Cereal bars prepared according to Table 12 below show preparations using “full” and reduced sugar (e.g., as described herein).

TABLE 12
Preparation of cereal bars.

| | Cereal Bars | | Sugar-Reduced |
|---|---|---|---|
| | prepared | | Cereal Bars (sugar |
| | with Full | Sugar-Reduced | associated with a |
| | Sugar | Cereal Bars | carrier) |
| Glucose 65 Bx | 19.2 | 9.6 | 9.6 |
| Sucrose | 16.3 | 8.75 | |
| Incredo sugar | | | 8.75 |
| Water | 9 | 9 | 9 |
| Canola oil | 3.2 | 3.2 | 3.2 |
| Lecithin | 0.1 | 0.1 | 0.1 |
| Glycerol | 0.5 | 0.5 | 0.5 |
| Fibrulose F97 | | 7.55 | 7.55 |
| IMOFibe | | 9.6 | 9.6 |
| Cereal | 40.2 | 40.2 | 40.2 |
| Nuts | 11.5 | 11.5 | 11.5 |
| Oats | | 0.00 | 0 |
| TOTAL SUGARS | 25.2 | 15.8 | 15.8 |
| REDUCTION | | 37.02% | 37.02% |
| TOTAL % | 100 | 100 | 100 |

Cereals are weighed out and gently broken up by hand. Ingredients for syrup are weighed in Thermomix. For the sugar-reduced, carrier-associated product, sugar is added last. The mixtures are cooked at speed 2.5 until the mixture hit about 110 and then cooked for about 5 minutes more for a total of about 9 minutes overall. Syrup is poured onto cereals and the resultant mixture is mixed on speed 1-2 for about 30 seconds. The mixture is pressed firmly and evenly into quarter pan molds to a thickness of about 1 centimeter to ensure formation of a bar. The bars are dried overnight or longer.

Table 13 shows a taste test comparison of the full sugar granola bar compared to the sugar-reduced preparation, while Table 14 shows a taste test comparison of the sugar-reduced preparation compared to the sugar-reduced preparation using sugar associated with a carrier (e.g., as described herein).

TABLE 13
Taste test of full sugar and sugar-reduced cereal bars.

Best Tasting Cereal Bar?

| | Cereal Bars prepared | Sugar-Reduced |
|---|---|---|
| Taster | with Full Sugar | Cereal Bars |
| Total | 21 | 8 |
| % | 72 | 28 |

TABLE 14
Taste test of reduced sugar cereal bars.

Best Tasting Cereal Bar?

| | | Sugar-Reduced Cereal |
|---|---|---|
| | Sugar-Reduced | Bars (sugar associated |
| Taster | Cereal Bars | with a carrier) |
| Total | 4 | 11 |
| % | 27 | 73 |

As shown in Table 13, reducing normal sugar results in missing sweetness. As shown in Table 14, the use of a carrier material as described herein provides enhanced sweetness over other sugar reduced preparations. That is, replacement of glucose syrup by dietary fiber has the dual effect of providing a sweeter, taste-preferred composition while also saving on materials costs for preparation of the food product.

### Example 7: Preparation of Candy Products

Gummy candies are prepared as described in the preceding examples. A variety of recipes are used. Table 15 shows an example preparation of gummy candies using glucose syrup and sucrose or glucose syrup prepared using sugar associated with a carrier and sucrose.

TABLE 15
Preparation of gummy candies.

| | | | Gummy Candy with | |
|---|---|---|---|---|
| | Gummy Candy | | carrier material | |
| Ingredients | g | % | g | % |
| Glucose syrup | 144.0 | 36.0 | 0.0 | 0.0 |
| Glucose syrup | 0.0 | 0.0 | 144.0 | 36.0 |
| associated with carrier | | | | |
| Sucrose | 144.0 | 36.0 | 144.0 | 36.0 |
| Water 1 | 33.6 | 8.4 | 33.6 | 8.4 |
| Citric acid | 1.2 | 0.3 | 1.2 | 0.3 |
| Total syrup mix | 322.8 | | 322.8 | |
| Water 2 (30-40° C.) | 40.0 | 10.0 | 40.0 | 10.0 |
| Beef Gelatin 240 bloom | 24.0 | 6.0 | 24.0 | 6.0 |
| Orange Flavor Givaudan | 0.24 | 0.06 | 0.24 | 0.06 |
| Beta carotene 1.3% (10%) | 0.80 | 0.200 | 0.80 | 0.200 |
| Water 3 | 12.0 | 3.0 | 12.0 | 3.0 |
| Total | 399.8 | 100 | 399.8 | 100 |

Table 16 shows an example preparation of gummy candies using glucose syrup and sucrose or glucose syrup and sucrose associated with a carrier.

TABLE 16
Preparation of gummy candies.

| | | | Gummy Candy with | |
|---|---|---|---|---|
| | Gummy Candy | | carrier material | |
| Ingredients | g | % | g | % |
| Glucose syrup | 144.0 | 36.0 | 144.0 | 36.0 |
| Sucrose | 144.0 | 36.0 | 0.0 | 0.0 |
| Sucrose associated | 0.0 | 0.0 | 144.0 | 36.0 |
| with carrier | | | | |
| Water 1 | 33.6 | 8.4 | 33.6 | 8.4 |
| Citric acid | 1.2 | 0.3 | 1.2 | 0.3 |
| Total syrup mix | 322.8 | | 322.8 | |
| Water 2 (30-40° C.) | 40.0 | 10.0 | 40.0 | 10.0 |
| Beef Gelatin 240 bloom | 24.0 | 6.0 | 24.0 | 6.0 |
| Orange Flavor Givaudan | 0.24 | 0.06 | 0.24 | 0.06 |
| Beta carotene 1.3% (10%) | 0.80 | 0.200 | 0.80 | 0.200 |
| Water 3 | 12.0 | 3.0 | 12.0 | 3.0 |
| Total | 399.8 | 100 | 399.8 | 100 |

Table 17 shows an example preparation of gummy candies using glucose syrup and sucrose or glucose syrup and sucrose associated with a carrier. Carnauba wax is added after mixing of other elements.

TABLE 17
Preparation of gummy candies.

| | | | Gummy Candy with | |
|---|---|---|---|---|
| | Gummy Candy | | carrier material | |
| Ingredients | g | % | g | % |
| Glucose syrup 65% | 144.0 | 36.0 | 144.0 | 36.0 |
| Sucrose | 144.0 | 36.0 | 0.0 | 0.0 |
| Sucrose associated | 0.0 | 0.0 | 144.0 | 36.0 |
| with carrier | | | | |
| Water 1 | 33.6 | 8.4 | 33.6 | 8.4 |
| Total syrup mix | 321.6 | | 321.6 | |
| Water 2 (30-40° C.) | 40.0 | 10.0 | 40.0 | 10.0 |
| Beef Gelatin 240 bloom | 24.0 | 6.0 | 24.0 | 6.0 |
| Citric acid | 1.2 | 0.3 | 1.2 | 0.3 |
| FROTAROM Lemon flavor | | | | |
| Beta carotene 1.3% (10%) | | | | |
| *Mixed flavors | 3.2 | 0.800 | 3.2 | 0.800 |
| Water 3 | 9.1 | 2.3 | 9.1 | 2.28 |
| Total | 399.1 | 99.9 | 399.1 | 99.86 |
| Carnauba wax | 0.8 | 0.2 | 0.8 | 0.2 |
| (CAPOL 307A) | | | | |

Table 18 shows an example preparation of gummy candies using glucose syrup and sucrose or glucose syrup and sucrose associated with a carrier. Carnauba wax is added after mixing of other elements.

TABLE 18
Preparation of gummy candies.

| | | | Gummy Candy with | |
|---|---|---|---|---|
| | Gummy Candy | | carrier material | |
| Ingredients | g | % | g | % |
| Glucose syrup 80 Bx | 130.0 | 32.5 | 130.0 | 32.5 |
| Sucrose | 160.0 | 40.0 | 0.0 | 0.0 |
| Sucrose associated | 0.0 | 0.0 | 160.0 | 40.0 |
| with carrier | | | | |
| Water 1 | 40.0 | 10.0 | 40.0 | 10.0 |
| Citric acid | 1.2 | 0.3 | 1.2 | 0.3 |
| Total syrup mix | 331.2 | | 331.2 | |
| Water 2 | 40.0 | 10.0 | 40.0 | 10.0 |
| Beef Gelatin 240 bloom | 24.0 | 6.0 | 24.0 | 6.0 |
| Watermelon flavor | 0.24 | 0.06 | 0.24 | 0.06 |
| Beta carotene 1.3% (10%) | 0.08 | 0.020 | 0.08 | 0.02 |
| Water 3 | 4.0 | 1.0 | 4.0 | 1.00 |
| Total | 399.5 | 99.9 | 399.5 | 99.9 |
| Carnauba wax | 0.8 | 0.2 | 0.8 | 0.2 |
| (CAPOL 307A) | | | | |

Table 19 shows an example preparation of gummy candies using glucose syrup and sucrose or glucose syrup prepared with sugar associated with a carrier and sucrose. Carnauba wax is added after mixing of other elements.

TABLE 19
Preparation of gummy candies.

| | | | Gummy Candy with | |
|---|---|---|---|---|
| | Gummy Candy | | carrier material | |
| Ingredients | g | % | g | % |
| Glucose syrup 80 Bx | 130.0 | 32.5 | 0.0 | 0.0 |
| Glucose syrup 80 Bx | 0.0 | 0.0 | 130.0 | 32.5 |
| associated with carrier | | | | |
| Sucrose | 160.0 | 40.0 | 160.0 | 40.0 |
| Water 1 | 40.0 | 10.0 | 40.0 | 10.0 |
| Citric acid | 1.2 | 0.3 | 1.2 | 0.3 |
| Total syrup mix | 331.2 | | 331.2 | |
| Water 2 | 40.0 | 10.0 | 40.0 | 10.0 |
| Beef Gelatin 240 bloom | 24.0 | 6.0 | 24.0 | 6.0 |
| Watermelon flavor | 0.24 | 0.06 | 0.24 | 0.06 |
| Beta carotene 1.3% (10%) | 0.08 | 0.020 | 0.08 | 0.02 |
| Water 3 | 4.0 | 1.0 | 4.0 | 1.00 |
| Total | 399.5 | 99.9 | 399.5 | 99.9 |
| Carnauba wax | 0.8 | 0.2 | 0.8 | 0.2 |
| (CAPOL 307A) | | | | |

Table 20 shows an example preparation of gummy candies using glucose syrup and sucrose or glucose syrup and sucrose associated with a carrier. Carnauba wax is added after mixing of other elements.

TABLE 20
Preparation of gummy candies.

| | | | Gummy Candy with | |
|---|---|---|---|---|
| | Gummy Candy | | carrier material | |
| Ingredients | g | % | g | % |
| Glucose syrup | 144.0 | 36.0 | 144.0 | 36.0 |
| Sucrose | 144.0 | 36.0 | 0.0 | 0.0 |
| Sucrose associated | 0.0 | 0.0 | 144.0 | 36.0 |
| with a carrier | | | | |
| Water 1 | 33.6 | 8.4 | 33.6 | 8.4 |
| Citric acid | 1.2 | 0.3 | 1.2 | 0.3 |
| Total syrup mix | 322.8 | | 322.8 | |
| Water 2 | 40.0 | 10.0 | 40.0 | 10.0 |
| Beef Gelatin 240 bloom | 24.0 | 6.0 | 24.0 | 6.0 |
| Watermelon flavor | 0.24 | 0.06 | 0.24 | 0.06 |
| Beta carotene 1.3% (10%) | 0.16 | 0.040 | 0.08 | 0.02 |
| Water 3 | 12.0 | 3.0 | 12.0 | 3.0 |
| Total | 399.2 | 99.8 | 399.1 | 99.8 |
| Carnauba wax | 0.8 | 0.2 | 0.8 | 0.2 |
| (CAPOL 307A) | | | | |

Table 21 shows an example preparation of gummy candies using glucose syrup and sucrose or glucose syrup associated with a carrier and sucrose.

TABLE 21
Preparation of gummy candies.

| | | | Gummy Candy with | |
|---|---|---|---|---|
| | Gummy Candy | | carrier material | |
| Ingredients | g | % | g | % |
| Glucose syrup | 144.0 | 36.0 | 144.0 | 36.0 |
| Glucose syrup | 0.0 | 0.0 | 144.0 | 36.0 |
| associated with carrier | | | | |
| Sucrose | 144.0 | 36.0 | 144.0 | 36.0 |
| Water 1 | 33.6 | 8.4 | 33.6 | 8.4 |
| Citric acid | 1.2 | 0.3 | 1.2 | 0.3 |
| Total syrup mix | 322.8 | | 322.8 | |
| Water 2 (30-40° C.) | 40.0 | 10.0 | 40.0 | 10.0 |
| Beef Gelatin 240 bloom | 24.0 | 6.0 | 24.0 | 6.0 |
| Orange flavor Givaudan | 0.24 | 0.06 | 0.24 | 0.06 |
| Beta carotene 1.3% (10%) | 0.80 | 0.200 | 0.08 | 0.200 |
| Water 3 | 12.0 | 3.0 | 12.0 | 3.0 |
| Total | 399.8 | 100.0 | 399.8 | 100.0 |

Table 22 shows an example preparation of gummy candies using glucose syrup and sucrose or glucose syrup and sucrose associated with a carrier. Carnauba wax is added after mixing of other elements.

TABLE 22
Preparation of gummy candies.

| | | | Gummy Candy with | |
|---|---|---|---|---|
| | Gummy Candy | | carrier material | |
| Ingredients | g | % | g | % |
| Glucose syrup | 144.0 | 36.0 | 144.0 | 36.0 |
| Sucrose | 144.0 | 36.0 | 0.0 | 0.0 |
| Sucrose associated | 0.0 | 0; 0 | 144.0 | 36.0 |
| with carrier | | | | |
| Water 1 | 33.6 | 8.4 | 33.6 | 8.4 |
| Citric acid | 1.2 | 0.3 | 1.2 | 0.3 |
| Total syrup mix | 322.8 | | 322.8 | |
| Water 2 (30-40° C.) | 40.0 | 10.0 | 40.0 | 10.0 |
| Fish Gelatin 240 bloom | 24.0 | 6.0 | 24.0 | 6.0 |
| Givaudan Passionfruit | 0.32 | 0.08 | 0.32 | 0.08 |
| flavor | | | | |
| Beta carotene 1.3% | 0.08 | 0.020 | 0.08 | 0.200 |
| Water 3 | 12.0 | 3.0 | 12.0 | 3.0 |
| Total | 399.2 | 99.8 | 399.2 | 99.8 |
| Carnauba wax | 0.8 | 0.2 | 0.8 | 0.2 |
| (CAPOL 307A) | | | | |

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A candy product comprising a dietary fiber and a sweetener material that comprises sucrose, wherein the candy product (i) comprises less than 60% weight/weight (w/w) of a caloric, crystallization-interfering agent, (ii) is amorphous at room temperature, and (iii) has a soft or chewy texture.

2. (canceled)

3. (canceled)

4. The candy product of claim 1, wherein the dietary fiber is selected from the group consisting of dextrin, maltodextrin, inulin, psyllium, beta-glucan, lignin, chitin, galactomannan, resistant starch, arabinoxylan, glucomannan, pectin, cellulose, methylcellulose, hemicellulose, and combinations thereof.

5. (canceled)

6. The candy product of claim 1, wherein the sweetener material comprises a carrier material associated with sucrose.

7. The candy product of claim 6, wherein the carrier material is silica.

8. The candy product of claim 6, wherein the sweetener material comprises sucrose that has been homogenized with the carrier material.

9. The candy product of claim 1, wherein the caloric, crystallization-interfering agent is selected from the group consisting of glucose syrup, corn syrup, honey, hydrogenated starch hydrolysate, and a combination thereof.

10. (canceled)

11. The candy product of claim 1, wherein the candy product has a higher relative sweetness (RS) than a control candy product without the caloric, crystallization-interfering agent.

12. The candy product of claim 1, wherein the candy product is essentially free of the caloric, crystallization-interfering agent.

13. The candy product of claim 1, further comprising one or more flavors, dyes, or acids.

14-18. (canceled)

19. The candy product of claim 1, wherein the candy product is a gummy candy, jelly candy, cotton candy, nougat, taffy, caramel, sweetener syrup, or marshmallow candy.

20-92. (canceled)

93. A method of preparing a consumable product, the method comprising combining an interfering agent and a sweetener material that comprises sucrose to provide a sweetener mixture,
wherein the interfering agent is (i) a dietary fiber or (ii) a combination of a dietary fiber and a caloric, crystallization-interfering agent, wherein the sweetener mixture comprises less than 50% of the caloric, crystallization-interfering agent,
wherein the consumable product is amorphous at room temperature, and
wherein the consumable product has a soft or chewy texture.

94. (canceled)

95. The method of claim 93, wherein the consumable product is essentially free of the caloric, crystallization-interfering agent.

96. The method of claim 93, wherein the method does not comprise the use of a caloric, crystallization-interfering agent.

97. The method of claim 93, wherein the caloric, crystallization-interfering agent is selected from the group consisting of glucose syrup, corn syrup, honey, hydrogenated starch hydrolysate, and a combination thereof.

98-100. (canceled)

101. The method of claim 93, wherein the sweetener material comprises a carrier material associated with sucrose.

102. The method of claim 101, wherein the sweetener material comprises about 0.001-4% carrier material weight/weight relative to sucrose.

103. The method of claim 101, wherein the sweetener material comprises sucrose that has been homogenized with the carrier material.

104. The method of claim 93, wherein one or more flavors, dyes, or acids are added to the sweetener mixture.

105. (canceled)

106. (canceled)

107. The method of claim 93, wherein the dietary fiber is selected from the group consisting of dextrin, maltodextrin, inulin, psyllium, beta-glucan, lignin, chitin, galactomannan, resistant starch, arabinoxylan, glucomannan pectin, cellulose, methylcellulose, hemicellulose, and a combination thereof.

108-122. (canceled)

123. The method of claim 93, wherein the consumable product is a gummy candy, jelly candy, cotton candy, nougat, taffy, caramel, sweetener syrup, or marshmallow candy.

124. (canceled)

125. (canceled)
